(19) United States
(12) Patent Application Publication
(10) Pub. No.: US 2025/0308758 A1
(43) Pub. Date: Oct. 2, 2025

(54) COIL COMPONENT AND METHOD FOR MANUFACTURING COIL COMPONENT

(71) Applicant: TAIYO YUDEN CO., LTD., Tokyo (JP)

(72) Inventor: Shintaro TAKAHASHI, Tokyo (JP)

(21) Appl. No.: 19/083,915

(22) Filed: Mar. 19, 2025

(30) Foreign Application Priority Data
Mar. 29, 2024 (JP) 2024-056514

(51) Int. Cl. H01F 27/30

(52) U.S. Cl. CPC H01F 27/306

(57) ABSTRACT

A coil component includes: a base including a metal magnetic particle and a binder; and a coil conductor arranged in the base. The base includes a first base and a second base. The first base includes a first surface facing the coil conductor. The first surface includes a first area that is a continuous flat surface and a second area other than the first area. The second base is connected to the first base at least in the second area of the first base. The first base includes a recess in the second area.

### CROSS-REFERENCE TO RELATED APPLICATIONS

The present application is based on and claims priority to Japanese Patent Application No. 2024-056514 filed on Mar. 29, 2024, the entire contents of which are hereby incorporated by reference.

### BACKGROUND

### 1. Field of the Invention

The present disclosure relates to a coil component and a method for manufacturing the coil component.

### 2. Description of the Related Art

Coil components are mounted in various electronic devices. In recent years, miniaturization and performance enhancement have been required for electronic devices, and miniaturization and performance enhancement are also required for coil components mounted in electronic devices.

As a coil component to be mounted in electronic devices, a coil component that includes a coil conductor and a base arranged so as to surround the coil conductor and uses a composite-metal base as the base has been conventionally used. For example, Japanese Laid-Open Patent Application No. 2020-202325 discloses a coil component including a coil and a magnetic core member, and in which at least a part of the magnetic core member is formed of a thermoset of a metal magnetic composite material.

### SUMMARY

The coil component of the present disclosure includes a base including metal magnetic particles and a binder; a coil conductor arranged in the base; the base includes a first base and a second base; the first base includes a first surface facing the coil conductor; the first surface includes a first area that is a continuous flat surface and a second area other than the first area; the second base is connected to the first base at least in the second area of the first base, and the first base includes a recess in the second area.

### BRIEF DESCRIPTION OF THE DRAWINGS

FIG. 1 is a perspective view of a coil component according to one embodiment of the present disclosure;

FIG. 2 is a cross-sectional view of an example configuration of the coil component taken along a line A-A of FIG. 1;

FIG. 3 is a cross-sectional view of the coil component taken along a line B-B of FIG. 2;

FIG. 4 is a cross-sectional view of another configuration example of the coil component taken along the line A-A in FIG. 1;

FIG. 5 is a flowchart of a method for manufacturing the coil component according to the embodiment of the present disclosure;

FIG. 6A is a drawing for explaining a first-base formation in the method for manufacturing the coil component according to the embodiment of the present disclosure;

FIG. 6B is another drawing for explaining the first-base formation in the method for manufacturing the coil component according to the embodiment of the present disclosure;

FIG. 6C is still another drawing for explaining the first-base formation in the method for manufacturing the coil component according to the embodiment of the present disclosure;

FIG. 7A is a drawing for explaining a coil conductor installation in the method for manufacturing the coil component according to the embodiment of the present disclosure;

FIG. 7B is a drawing for explaining a second-base formation in the method for manufacturing the coil component according to the embodiment of the present disclosure; and

FIG. 7C is a drawing for explaining polishing in the method for manufacturing the coil component according to the embodiment of the present disclosure.

### DETAILED DESCRIPTION OF THE DISCLOSURE

When a coil component includes a coil conductor and a base arranged so as to surround the coil conductor, and the base is a composite-metal base, the base is manufactured through multiple processes in order to raise positional accuracy of the coil conductor in the coil component. Therefore, the base is formed of multiple members, and the multiple members are bonded together in a manufacturing process to form the base.

Additionally, when the coil component is to be mounted on an electronic device, there are cases in which thermal-processing cycles are repeatedly applied to the coil component. In such cases, when the thermal-processing cycles are repeatedly applied to the coil component, a space may be formed between the coil conductor and the base due to differences such as in thermal expansion properties between the coil conductor and the base.

In the case where the base is a composite-metal base, since the base is formed by bonding a plurality of members together as described above, the strength at parts where the members are bonded may become weak, and the base may become susceptible to damage depending on the size of the generated space.

The present disclosure provides a coil component capable of preventing the base from being damaged even when repeatedly subjected to thermal- processing cycles.

One embodiment (hereinafter referred to as “embodiment”) of the present disclosure will be described in detail in the following, but the present disclosure is not limited thereto. In the present specification and drawings, components having substantially the same functional configuration may be omitted from duplicate descriptions by assigning the same reference numerals. Each of the drawings is a schematic diagram illustrated for the purpose of explaining the arrangement of each member, etc., and is not necessarily illustrated based on an accurate scale.

In this specification, “first”, “second”, etc., may be added to the names of members, parts, etc., such as “first base”, “second base”, etc. However, “first”, “second”, etc., are used only to distinguish each member and to prevent confusion in explanations. Therefore, “first”, “second”, etc., do not represent arrangement, priority, etc. In addition, when there is no risk of confusion or when the members are to be indicated collectively, the name of the members can be simply indicated such as “base”, etc., without using “first”, “second”, etc.

### Coil Component

A coil component of the present embodiment will be described in the following.

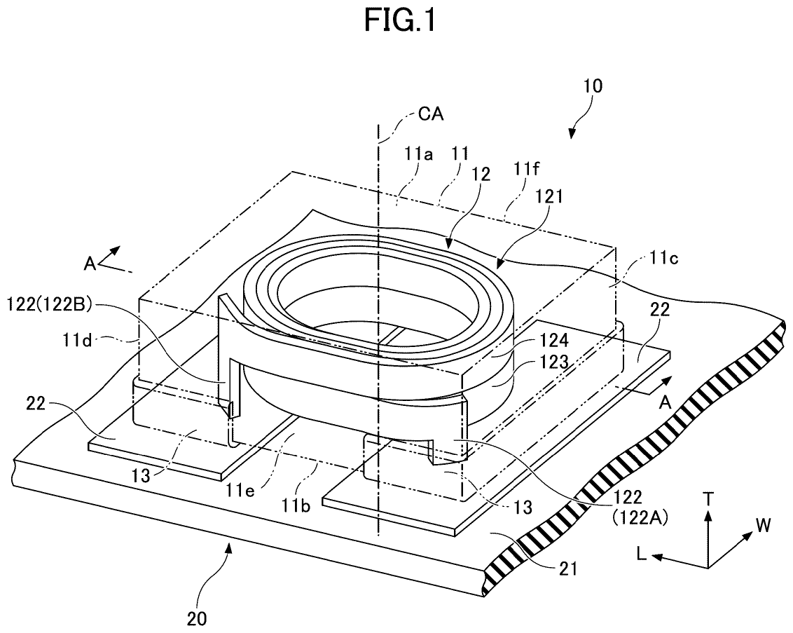

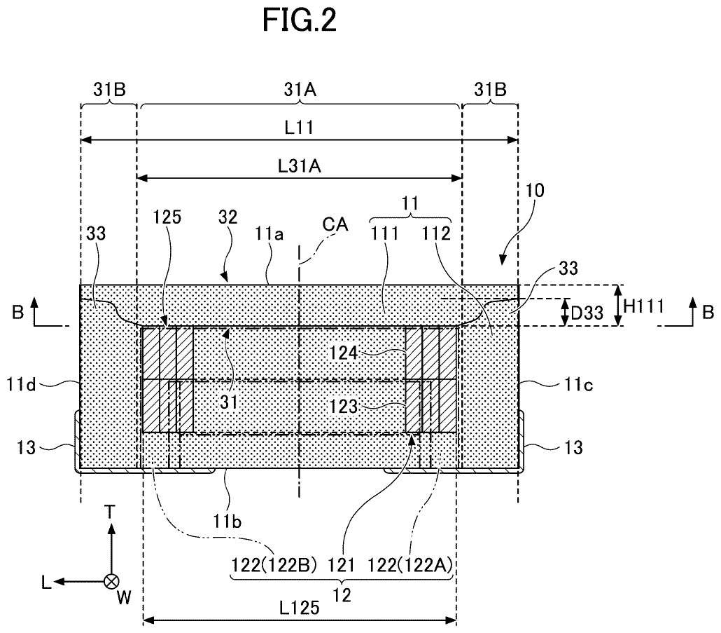

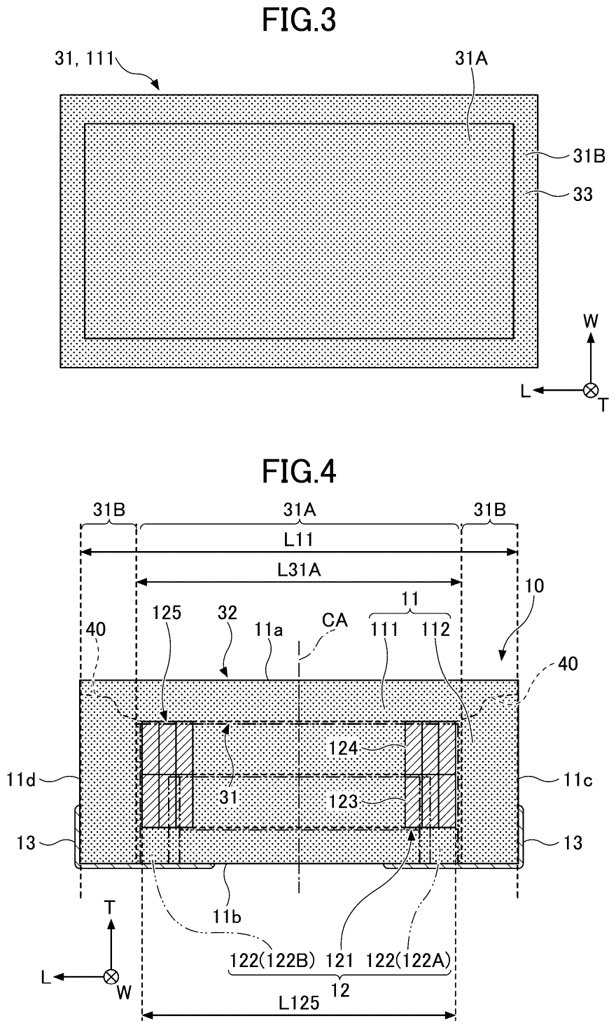

FIG. 1 is a perspective view of a coil component 10 of the present embodiment. Both a coil conductor 12, which is covered with a base 11 and is not visible from the outside, and members connected to the coil conductor 12 are illustrated such that the structure can be understood. FIG. 2 is a cross-sectional view of the coil component 10 according to a first configuration example taken along the line A-A of FIG. 1. FIG. 3 is a cross-sectional view of the coil component 10 taken along the line B-B of FIG. 2. FIG. 4 is a cross-sectional view of the coil component 10 according to a second configuration example taken along the line A-A of FIG. 1. Although lead-out portions 122 are not illustrated in the cross-sectional view taken along the line A-A of FIG. 1, the lead-out portions 122 are shown with two-dot dash lines in FIGS. 2 and 4 such that a relationship with the coil conductor 12 and the like is clear.

### (1) Configuration of Coil Component

The coil component 10 according to the present embodiment will be described with reference to FIGS. 1 to 4. The coil component of the present embodiment is an inductor and can be used as a power inductor incorporated in a power supply line or other various types of inductors.

As illustrated in FIG. 1, the coil component 10 includes the base 11 and the coil conductor 12 disposed in the base 11. In addition to the base 11 and the coil conductor 12, the coil component 10 may also include external electrodes 13 for connecting to terminals or the like of a substrate to be mounted.

The coil component 10 can be mounted on a mount substrate 21 provided with land pads 22. The coil component 10 is mounted on the mount substrate 21 by bonding the external electrodes 13 to the land pads 22. A circuit board 20 may include a coil component 10 and a mount substrate 21 on which the coil component 10 is mounted. The circuit board 20 may include any other electronic components necessary for forming an electrical circuit other than the coil component 10.

The circuit board 20 including the coil component 10 among other components, can be mounted on various electronic devices such as mobile terminals such as smartphones, electric components of automobiles, servers and personal computers used in work offices and data centers, and control devices in various factories. The electronic devices on which the coil component 10 of the present embodiment is mounted are not limited to those specified in this specification.

The shape of the base 11 is not particularly limited, but may have a rectangular parallelepiped shape as illustrated in FIG. 1, for example. The rectangular parallelepiped shape here does not have a strict geometric meaning. For example, corners connecting a plurality of surfaces may be chamfered, and the corners of the surfaces need not necessarily be right angles. In FIG. 1, each surface of the base 11, such as a first main surface 11a, is illustrated as a plane, but may be curved. In addition, the sides connecting the surfaces of the base 11, that is, the boundary lines between the surfaces, need not necessarily be straight, but may be curved according to the shape of the surfaces.

The base 11 may include, for example, the first main surface 11a, a second main surface 11b, a first end-surface 11c, a second end-surface 11d, a first side surface 11e, and a second side surface 11f. The first main surface 11a and the second main surface 11b are surfaces located on opposite sides of the base 11. The first end-surface 11c and the second end-surface 11d are surfaces located on opposite sides of the base 11. The first side surface 11e and the second side surface 11f are surfaces located on opposite sides of the base 11. The outer edge of the first main surface 11a can be defined by four sides. In the case of FIG. 1, the outer edge of the first main surface 11a can be defined by a pair of short sides and a pair of long sides. Like the first main surface 11a, the outer edge of the second main surface 11b can be defined by a pair of short sides and a pair of long sides. The first end-surface 11c can connect the short side of the first main surface 11a and the short side of the second main surface 11b, and the second end-surface 11d can connect the other short side of the first main surface 11a and the other short side of the second main surface 11b. The first side surface 11e can connect the long side of the first main surface 11a and the long side of the second main surface 11b, and the second side surface 11f can connect the other long side of the first main surface 11a and the other long side of the second main surface 11b.

When the coil component 10 is mounted on the mount substrate 21 as illustrated in FIG. 1, the first main surface 11a is located on an upper side of the base 11, and the second main surface 11b is located on a lower side of the base 11. For this reason, the first main surface 11a is sometimes referred to as “upper surface” and the second main surface 11b is sometimes referred to as “lower surface”. Since the coil component 10 is arranged such that the second main surface 11b faces the mount substrate 21, the second main surface 11b is sometimes referred to as the “mounting surface”. In this specification, unless the context otherwise requires, “length”, “width”, and “height” directions of the coil component 10 are “L-axis”, “W-axis”, and “T-axis” directions of FIG. 1, respectively. An L-axis, a W-axis, and a T-axis are orthogonal to each other.

The size of the coil component 10 is not particularly limited, but the coil component 10 can be a small coil component. In this case, the coil component 10 may have, for example, the length (in the L-axis direction) of 0.2 mm or more and 4.0 mm or less, the width (in the W-axis direction) of 0.1 mm or more and 4.0 mm or less, and the height (in the T-axis direction) of 0.1 mm or more and 4.0 mm or less. The coil component 10 may be configured such that the length is greater than the width.

When the length of the coil component 10 is greater than the width, the direction along the L-axis is called a long-side direction of the coil component 10, and the direction along the W-axis is called a short-side direction of the coil component 10. The length in the short-side direction of the coil component 10 may be 3.0 mm or less. At least one of the length, width, or height of the coil component 10 may be 4.0 mm or less, 2.0 mm or less, 1.0 mm or less, or 0.65 mm or less. The coil component 10 may be thin. Specifically, the length of the coil component 10 may be greater than the height. The length of the coil component 10 may be two or more times the height, or three or more times the height.

The height of the coil component 10 may be 1 mm or less.

These dimensions are only examples, and the coil component 10 of the present embodiment may have any dimensions.

### (2) Coil Conductor

The coil conductor 12 includes a circumferential portion 121 extending in a circumferential direction around a central axis CA of the coil conductor 12, and the lead-out portions 122. The lead-out portions 122 include a first lead-out portion 122A extending from a first end, which is one end of the coil conductor 12 in a longitudinal direction of the circumferential portion 121, to the second main surface 11b, which is the lower surface of the base 11. The lead-out portions 122 include a second lead-out portion 122B extending from a second end, which is located on an opposite side in the longitudinal direction of the first end of the circumferential portion 121, to the second main surface 11b, which is the lower surface of the base 11. The coil conductor 12 is disposed in the base 11, that is, inside the base 11. In other words, the coil conductor 12 is positioned inside a space surrounded by the first main surface 11a, the second main surface 11b, the first end-surface 11c, the second end-surface 11d, the first side surface 11e, and the second side surface 11f of the base 11, and is embedded in the base 11. The end surface of the first lead-out portion 122A and the end surface of the second lead-out portion 122B are exposed to the outside of the base 11 from the second main surface 11b, which is the lower surface of the base 11. The first lead-out portion 122A and the second lead-out portion 122B can be connected to the external electrodes 13 at the end surfaces exposed from the base 11.

The central axis CA of the coil conductor 12 may be a straight line passing through the coil component 10 along the T-axis, the geometric center of gravity of the coil conductor 12 when viewed from the first main surface 11a, which is an upper surface of the base 11, and the geometric center of gravity of the coil conductor 12 when viewed from the second main surface 11b, which is a lower surface of the base 11. The central axis CA may be, for example, an axis along the T-axis.

In FIG. 1, the circumferential portion 121 includes a first circumferential portion 123 wound around the central axis CA starting from the first lead-out portion 122A for a plurality of turns, and a second circumferential portion 124 wound around the central axis CA and located closer to the first main surface 11a, which is the upper surface of the base 11, than the first circumferential portion 123 is. That is, in FIG. 1, the circumferential portion 121 has a two-layer structure in which the first circumferential portion 123 and the second circumferential portion 124 are stacked on top of each other along the T-axis. The end of the first circumferential portion 123 is connected to the first lead-out portion 122A. The end of the second circumferential portion 124 is connected to the second lead-out portion 122B.

In FIG. 1, each of the first circumferential portion 123 and the second circumferential portion 124 may be wound around the central axis CA once or more times in the circumferential direction. The number of winding times of the first circumferential portion 123 and the second circumferential portion 124 is not particularly limited, and may be wound, for example, 1.5 times or 2.5 times respectively. The number of winding times of the first circumferential portion 123 and the second circumferential portion 124 is not limited to the number of winding times explicitly described in this specification. The circumferential portion 121 may have a single-layer structure, or may have a structure with three or more layers.

The coil conductor 12 may be formed of a material having excellent conductivity, such as copper (Cu), silver (Ag), or gold (Au), and may be formed in a band shape, for example. The surface of the coil conductor 12 may be covered with an insulation film. The insulation film covering the coil conductor 12 is not particularly limited, but may be formed of, for example, a thermosetting resin having excellent insulating properties. Specifically, the insulation film may include, for example, one or more kinds of resins having excellent insulating properties selected from polyurethane, polyamide-imide, polyimide, polyester, and polyester-imide.

### (3) Base

Next, the structure of the base 11 will be described.

The base 11 may be a composite-metal base formed of a magnetic composite material. The composite-metal base 11 is obtained, for example, by pressure-forming a slurry, granule, or pellet obtained by kneading a magnetic composite material containing metal magnetic particles and a binder (bonding material).

Therefore, the base 11 may contain metal magnetic particles and a binder. The binder may contain resin as a component connecting the metal magnetic particles.

### (3-1) Materials Contained in the Base

(Metal magnetic particles)

The metal magnetic particles contained in the base 11 may be composed of one kind of metal magnetic particles or may be a mixture of a plurality of kinds of metal magnetic particles. In the base 11, a plurality of metal magnetic particles are bonded by a resin contained in a bonding material.

The metal magnetic particles contained in the base 11 may be, for example, one or more kinds selected from (i) metallic particles such as iron (Fe) and nickel (Ni), (ii) crystalline alloy particles such as Fe-Si-Cr alloy, Fe-Si-Al alloy, Fe-Ni alloy, and (iii) amorphous alloy particles such as Fe-Si-Cr-B-C alloy, Fe-Si-Cr-B alloy. The metal magnetic particles contained in the base 11 may be one or more kinds of mixed particles selected from (i) to (iii) above.

The composition of the metal magnetic particles contained in the base 11 is not limited to the above composition. For example, the metal magnetic particles contained in the base 11 may be one or more kinds selected from among Co-Nb-Zr alloy, Fe-Zr-Cu-B alloy, Fe-Si-B alloy, Fe-Co-Zr-Cu-B alloy, Ni-Si-B alloy, and Fe-Al-Cr alloy. The metal magnetic particles contained in the base 11 may contain P.

The Fe-based metal magnetic particles contained in the base 11 may contain 95 wt % or more of Fe. An insulation film may be disposed on the surfaces of the metal magnetic particles. The insulation film may be an oxide film formed by oxidation of metallic elements contained in the metal magnetic particles. The insulation film provided on each surface of the metal magnetic particles may be a silicon oxide film. The silicon oxide film can be coated on the surfaces of the metal magnetic particles by, for example, a sol-gel method.

The average particle size of the metal magnetic particles is not particularly limited, but may be, for example, 1 μm or more and 60 μm or less, and may be 1 μm or more and 10 μm or less.

The measurement and calculation of the average particle size of the metal magnetic particles contained in the base 11 and inorganic particles described in the following can be performed by, for example, the following procedure. First, a cross section along a height direction (T-axis direction) of the base 11 is exposed, and the particle size distribution on a volume basis is obtained based on an SEM image of the exposed cross section taken by a scanning electron microscope (SEM). The average particle size is then determined based on the obtained particle size distribution on a volume basis. For example, the average particle size (median diameter (D50)) calculated from the particle size distribution on a volume basis of the metal magnetic particles obtained based on the SEM image can be used as the average particle size of the metal magnetic particles. The particle size distribution of each particle contained in the base 11 may be measured by a laser diffraction scattering method in accordance with JIS Z 8825 (2022). The particle size distribution of each particle contained in the base 11 can be measured by using a laser diffraction/scattering apparatus. For example, a laser diffraction particle size analyzer (model number: LA-960) manufactured by Horiba, Ltd. in Kyoto City, Kyoto Prefecture, Japan can be used to measure the particle size distribution of each particle contained in the base 11.

A content ratio of the metal magnetic particles in the base 11 can be selected in accordance with the characteristics required for the base 11 and the coil component 10, and is not particularly limited. The content ratio of metal magnetic particles in the base 11 may be, for example, 85 vol % or more, and may be 87 vol % or more. An upper limit value of the content ratio of the metal magnetic particles in the base 11 is not particularly limited, but may be, for example, less than 100 vol %. When the base 11 contains a plurality of kinds of metal magnetic particles, the content ratio of the metal magnetic particles means the total content of the plurality of kinds of metal magnetic particles. The content ratio of the metal magnetic particles in the base 11 can be obtained as an existence ratio based on an SEM image of an exposed cross section taken by a scanning electron microscope (SEM). An area ratio of the metal magnetic particles to the cross section of the base 11, which corresponds to the existence ratio of the metal magnetic particles found from the cross section, may be, for example, 85% or more, and may be 87% or more. The upper limit value of the area ratio of the metal magnetic particles to the cross section of the base 11, which corresponds to the existence ratio of the metal magnetic particles, is not particularly limited, but may be, for example, less than 100%.

### (Binding Material)

The base 11 can contain a binding material.

The binding material can include, for example, a thermosetting resin having excellent insulating properties. The resin material for the binding material includes, for example, one or more kinds selected from epoxy resin, polyimide resin, polystyrene (PS) resin, high-density polyethylene (HDPE) resin, polyoxymethylene (POM) resin, polycarbonate (PC) resin, polyvinylidene fluoride (PVDF) resin, phenolic resin, polytetrafluoroethylene (PTFE) resin, polybenzoxazole (PBO) resin, and the like.

### (Inorganic Particles)

The base 11 may contain inorganic particles. When the base 11 contains inorganic particles, the inorganic particles may be one or more kinds selected from SiO₂ particles (silica particles), Al₂O₃ particles (alumina particles), glass-based particles, and the like, and may be a mixture of one or more kinds selected from SiO₂ particles and the like, for example.

The average particle size of the inorganic particles may be 0.01 μm or more and 1 μm or less, for example.

When the base 11 contains inorganic particles, the inorganic particles enter the gaps between the metal magnetic particles and the arrangement of the metal magnetic particles can be stabilized. Therefore, when the base 11 contains inorganic particles, the mechanical strength of the base 11 can be enhanced.

### (3-2) Structure of Base

### (First Configuration Example)

Next, a first configuration example of the structure of the base 11 will be described with reference to FIG. 2.

The base 11 may have a first base 111 and a second base 112.

When the base 11 includes the first base 111 and the second base 112, the position of the coil conductor 12 can be precisely adjusted in the process of manufacturing the coil component 10, and the position of the coil conductor 12 in the base 11 can be appropriately positioned. Therefore, the characteristics of the coil component 10 can be accurately controlled, and a high performance can be achieved.

As illustrated in FIG. 2, the first base 111 can have a plate-like shape and includes a first surface 31 facing the coil conductor 12 and a second surface 32 facing the first surface 31.

The second surface 32 is the same surface as the first main surface 11a of the base 11. Therefore, the second surface 32 may be a flat surface.

The first surface 31 of the first base 111 includes a first area 31A that is a continuous flat surface and a second area 31B other than the first area 31A.

The second area 31B can be said to be an area outside the first area 31A of the first surface 31, that is, located on the side and end surfaces of the base 11. The second area 31B can be arranged at least in a part of the outer periphery of the first area 31A, and preferably is arranged over the entire outer periphery of the first area 31A. Here, FIG. 3 is a cross-sectional view taken along the line B-B of FIG. 2 that only illustrates the first base 111. FIG. 3 illustrates the first surface 31 of the first base 111. As illustrated in FIG. 3, the second area 31B can be arranged at least in a part of the outer periphery of the first area 31A, and preferably is arranged over the entire outer periphery of the first area 31A. However, the configuration is not limited to the configuration as illustrated in FIG.

3, and for example, the first area 31A can have any shape other than a rectangular shape, and the second area 31B can be arranged only in a part of the outer periphery of the first area 31A.

The continuous flat surface means, for example, a continuous surface in which a maximum value and a minimum value of the change in height along the T-axis are within ±3% of a median value.

The second base 112 can be connected to the first base 111 at least in the second area 31B of the first surface 31 of the first base 111.

The first base 111 may include a recess 33 recessed in the second area 31B in the height direction (T-axis direction) more than the first area 31A, that is, having a shorter distance from the second surface 32. The second base 112 is preferably filled and arranged in the recess 33 as well. Since the second area 31B of the first base 111 includes the recess 33, a contact area between the first base 111 and the second base 112 can be increased. Therefore, as compared with an existing coil component in which the second area 31B includes a flat surface similar to the first area 31A, the bonding strength between both members can be increased.

The coil conductor 12 can be formed of, for example, a metal having excellent conductivity.

Additionally, the base 11 can contain metal magnetic particles, a binder, etc. Therefore, it is difficult to increase the bonding strength between the coil conductor 12 and the base 11 formed of different materials. In contrast to this, the first base 111 and the second base 112, which are included in the base 11, have at least the same kinds of materials or at least the same main components, and thus can be readily bonded together. Therefore, it is easy to obtain sufficient bonding strength between the first base 111 and the second base 112, and the base 11 arranged to surround the coil conductor 12 can be made as a single member by integrating the first base 111 and the second base 112. Thus, in the coil component 10, the base 11 is unlikely to become damaged even when subjected to repeated thermal-processing cycles.

### (Depth of Recess)

A depth D33 of the recess 33 is not particularly limited, and can be selected according to the durability or the like against the thermal-processing cycles required for the coil component 10.

The depth D33 of the recess 33 can be longer than, for example, a major-axis diameter of one or more kinds of particles selected from first metal magnetic particles, which are metal magnetic particles of included in the first base 111, and second metal magnetic particles, which are metal magnetic particles included in the second base 112. The depth D33 of the recess 33 may be at least twice the length of the major-axis diameter of one or more kinds of particles selected from the first metal magnetic particles and the second metal magnetic particles.

By making the depth D33 of the recess 33 longer than the major-axis diameter of one or more kinds of particles selected from the first metal magnetic particles, which are the metal magnetic particles included in the first base 111, and the second metal magnetic particles, which are the metal magnetic particles included in the second base 112, the recess 33 can be made sufficiently deep. Therefore, in particular, the boding strength between the first base 111 and the second base 112 can be enhanced. Furthermore, when the coil component 10 is subjected to repeated thermal-processing cycles, the base 11 can be made to be particularly not appreciably damaged.

The major-axis diameter of the first metal magnetic particles is determined, for example, by the following procedure. The major-axis diameter of the second metal magnetic particles is determined by the same procedure except that the first base 111 is the second base 112 and the first metal magnetic particles are the second metal magnetic particles.

A cross section along the height direction (T-axis direction) of the base 11 is exposed, and the major-axis diameters of the first metal magnetic particles, which are a plurality of metal magnetic particles included in the first base 111, are measured based on an SEM image obtained by photographing the exposed cross section with a scanning electron microscope (SEM). The number of the first metal magnetic particles to be measured is not particularly limited, but it is preferable to select, for example, first metal magnetic particles having a major-axis diameter of 1 μm or more in the cross section, and to measure 50 to 100 first metal magnetic particles. A number-average diameter of the measured major-axis diameters of the first metal magnetic particles can be used as the major-axis diameter of the first metal magnetic particles.

Since the first area 31A of the first surface 31 is a flat surface, the depth D33 of the recess 33 can be evaluated based on the position of the first surface 31 in the first area 31A facing the coil conductor 12. When the first area 31A includes minute irregularities, the depth D33 of the recess 33 can be evaluated based on a central position of the first area 31A along the T-axis, that is, the central position in the height direction of the irregularities of the first area 31A.

The depth D33 of the recess 33 can be a maximum depth of the recess 33 along the T-axis.

The depth D33 of the recess 33 may be equal to or less than the height H111 of the first base 111, or may be less than the height H111 of the first base 111. Since the surface of the recess 33, that is, the surface in contact with the second base 112, is preferably not a flat surface, it is preferable to include a plurality of portions having different depths. For example, the recess 33 can have a wavy shape in the cross section along the height direction of the base 11, and preferably includes a plurality of inflection points. The recess 33 may also include a protrusion along the L-axis or the T-axis on its surface. The shape of the recess 33 need not necessarily be constant, but may be different depending on the position. The magnitude of the waviness including the protrusion in the recess 33 may be longer than the major-axis diameters of one or more kinds of particles selected from the first metal magnetic particles, which are the metal magnetic particles included in the first base 111, and the second metal magnetic particles, which are the metal magnetic particles included in the second base 112. The magnitude of the waviness in the recess 33 may be at least twice the length of the major-axis diameter of one or more kinds of particles selected from the first metal magnetic particles and the second metal magnetic particles.

### (Length of First Area)

The size of the first area 31A, which is a continuous flat surface of the first surface 31 of the first base 111, is not particularly limited, but is preferably not excessively large in order to sufficiently secure the size of the second area 31B and sufficiently increase the contact area between the first base 111 and the second base 112.

For example, in the cross section passing through the central axis CA of the coil conductor 12, a length L31A of the first area 31A of the first surface 31 of the first base 111 may be 80% or less of a length L11 of the base 11 along the first surface 31 in the cross section. By making the length L31A of the first area 31A in the cross section to be 80% or less of the length L11 of the base 11 along the first surface 31, the length of the second area 31B can be sufficiently secured, and the bonding strength between the first base 111 and the second base 112 can be particularly enhanced.

The length L31A of the first area 31A and the length L11 of the base 11 along the first surface 31 are both along the L-axis or the W-axis.

A lower limit of the size of the first area 31A is not particularly limited, but it is preferable to have a sufficient size with respect to the coil conductor 12 in order to enhance the positional accuracy of the coil conductor 12 installed in the first area 31A.

For example, in the cross section passing through the central axis CA of the coil conductor 12, the portion of the coil conductor 12 facing the first base 111 is defined as an upper portion 125. In this case, the length L31A of the first area 31A of the first base 111 may be 80% or more or 100% or more of the length of the upper portion 125 of the coil conductor 12.

### (Second Configuration Example)

Next, a second configuration example of the structure of the base 11 will be described with reference to FIG. 3.

In the first configuration example, a case

in which there is an interface between the first base 111 and the second base 112 and both members can be clearly identified has been described as an example, but the configuration is not limited thereto. For example, the first base 111 and the second base 112 may have a configuration including a transition area without a clear interface between both members.

That is, a transition area 40 may be provided between the second area 31B of the first base 111 and the second base 112.

The transition area 40 is an area located between the first base 111 and the second base 112 in the second area 31B as described above, but no clear boundary such as an interface is observed between the first base 111 and the second base 112. The transition area 40 means an area that transitions from the first base 111 to the second base 112. The transition area 40 may be an area where only a part of the interface is observed between the first base 111 and the second base 112, or an area where no interface is observed, for example, in the second area 31B.

When the type and composition of the metal magnetic particles and binder differ between the first base 111 and the second base 112, the transition area 40 can serve as a region where the composition transitions between the first base 111 and the second base 112.

When the type and composition of the contained metal magnetic particles and the resin contained in the binder are the same between the first base 111 and the second base 112, the transition area 40 can be an area where the interface of both members is partially or completely invisible due to a molding pressure during manufacturing, and the members are in a transition state.

The transition area 40 can be an area where the interface between the first base 111 and the second base 112 is not clear and both members are intermingled, thus it can be also called a mixed area.

The size and shape of the transition area 40 are not particularly limited, and can be any size and shape depending on the composition of the first base 111 and the second base 112, manufacturing conditions, etc.

By including a transition area 40 between the first base 111 and the second base 112, that is, an area where a clear interface between both members is thinned or completely invisible, the bonding strength between the first base 111 and the second base 112 can be particularly enhanced. The interface of the first area 31A and the second area 31B can be judged from the difference in contrast in SEM images taken by a scanning electron microscope (SEM), whereas the transition area 40 has no difference in contrast from either end of the first area 31A or the second area 31B, and the portion corresponding to the interface cannot be clearly confirmed.

Normally, when a force is applied between bonded members, they break at the interface between the members. Additionally, when the interface is not included between the bonded members, or almost no interface is included, there is no interface as a fracture starting point, and thus occurrence of fractures can be particularly suppressed.

Therefore, even when the coil component 10 according to the second configuration example is subjected to repeated thermal-processing cycles, the base 11 is unlikely to become damaged.

The coil component of the second configuration example can have the same configuration as that of the first configuration example except that the transition area 40 is provided between the second area 31B of the first base 111 and the second base 112. Therefore, descriptions that overlap with those of the first configuration example will be omitted.

The transition area 40 exists between the second area 31B of the first base 111 and the second base 112. Therefore, as in the case of the second area 31B of the first configuration example, the transition area 40 can be positioned outside the first area 31A of the first surface 31, that is, on the side and end surfaces of the base 11. The transition area 40 can be positioned at least in a part of the outer periphery of the first area 31A, and is preferably positioned on the entire outer periphery of the first area 31A.

### (4) External Electrodes

The external electrodes 13 are electrically connected to the coil conductor 12 through the first lead-out portion 122A and the second lead-out portion 122B. Therefore, the external electrodes 13 can be provided, for example, on the second main surface 11b, which is the lower surface of the base 11. In FIG. 1, one of the external electrodes 13 is configured and arranged to contact not only the second main surface 11b, which is the lower surface of the base 11, but also the first end-surface 11c, the first side surface 11e, and the second side surface 11f. In FIG. 1, the other of the external electrodes 13 is configured and arranged to contact not only the second main surface 11b, which is the lower surface of the base 11, but also the second end-surface 11d, the first side surface 11e, and the second side surface 11f. However, the configuration is not limited to the present embodiment, and for example, the external electrodes 13 may be configured and arranged to contact only the second main surface 11b, which is the lower surface of the base 11, and not to contact any surface other than the second main surface 11b of the base 11. The external electrodes 13 may be arranged to cover at least a part of the second main surface 11b, which is the lower surface of the base 11. In one embodiment, the external electrodes 13 may be configured and arranged not to contact the first main surface 11a, which is the upper surface of the base 11. Thus, the height of the coil component 10 can be particularly reduced.

The external electrodes 13 may include a metal layer (metal foil) formed by applying a conductive paste on the surface of the base 11 by screen printing or the like and heating the applied conductive paste. The thickness of the metal layer is not particularly limited, but may be, for example, 1 μm or more and 5 μm or less. The conductive paste may include one or more conductive materials excellent in conductivity selected from silver (Ag), palladium (Pd), copper (Cu), aluminum (Al), nickel (Ni), and alloys containing one or more elements selected from a group consisting of these elements. The metal content in the metal layer may be, for example, 99 wt % or more. The external electrodes 13 may include a plating layer formed on the metal layer. The plating layer may include two or more layers. When the plating layer includes two layers, the configuration of the two plating layers is not particularly limited, but may include, for example, a Ni plating layer and a Sn plating layer disposed outside the Ni plating layer. The thickness of the plating layer may be, for example, 1 μm or more and 5 μm or less. When a single external electrode 13 includes a metal layer and a plating layer, the thickness of the external electrode 13 may be, for example, 5 μm or more and 10 μm or less.

The external electrodes 13 may each include a conductive resin layer between the metal layer and the plating layer. When the external electrode 13 includes a metal layer, a plating layer, and a conductive resin layer, the thickness of the external electrode 13 may be, for example, 10 μm or more and 20 μm or less.

### Method for Manufacturing Coil Component

An exemplary method for manufacturing a coil component will be described in the following. According to the method for manufacturing the coil component, the coil component according to the embodiment of the present disclosure can be manufactured, and thus the description of the matters already described will be partially omitted. The method for manufacturing the coil component described in the following is only one example, and the method for manufacturing the coil component according to the embodiment of the present disclosure is not limited to the method described in the following.

The method for manufacturing the coil component of the present embodiment may include first-base formation (S51), coil conductor installation (S52), and second-base formation (S53), as illustrated in a flowchart 50 in FIG. 5. The method for manufacturing the coil component of the present embodiment may include polishing (S54) and external electrode formation (S55) after the second-base formation (S53), as necessary.

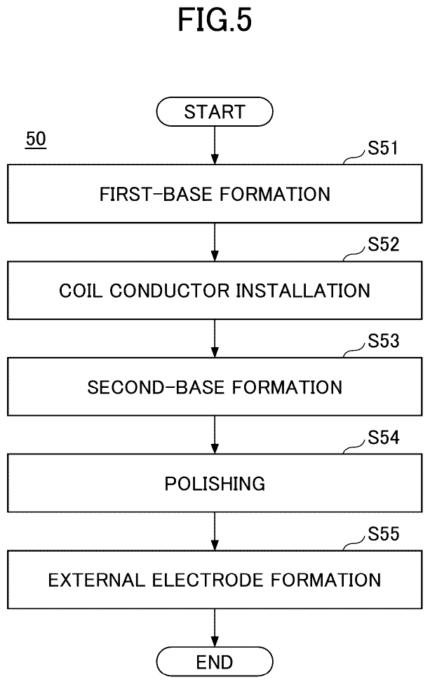

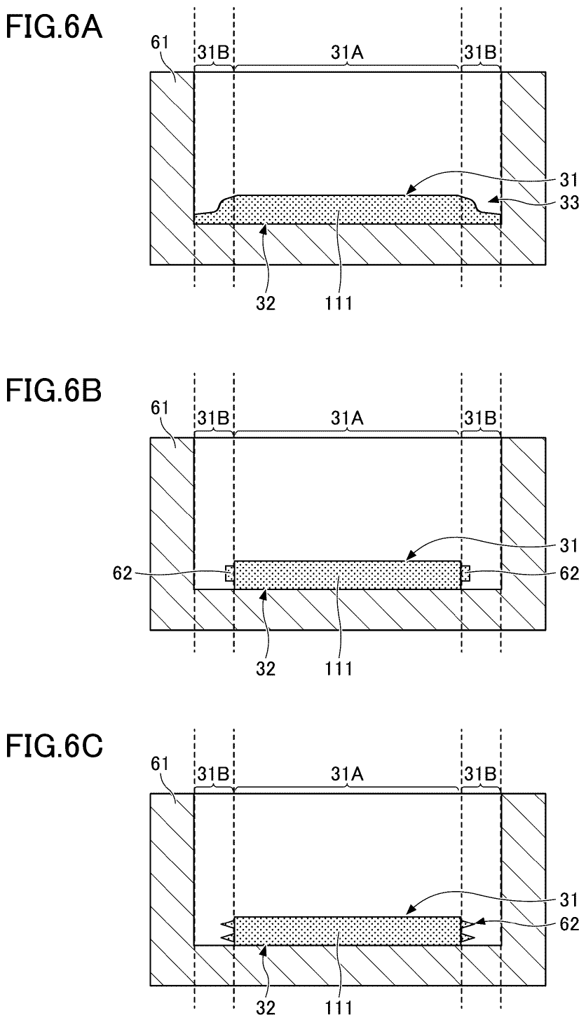

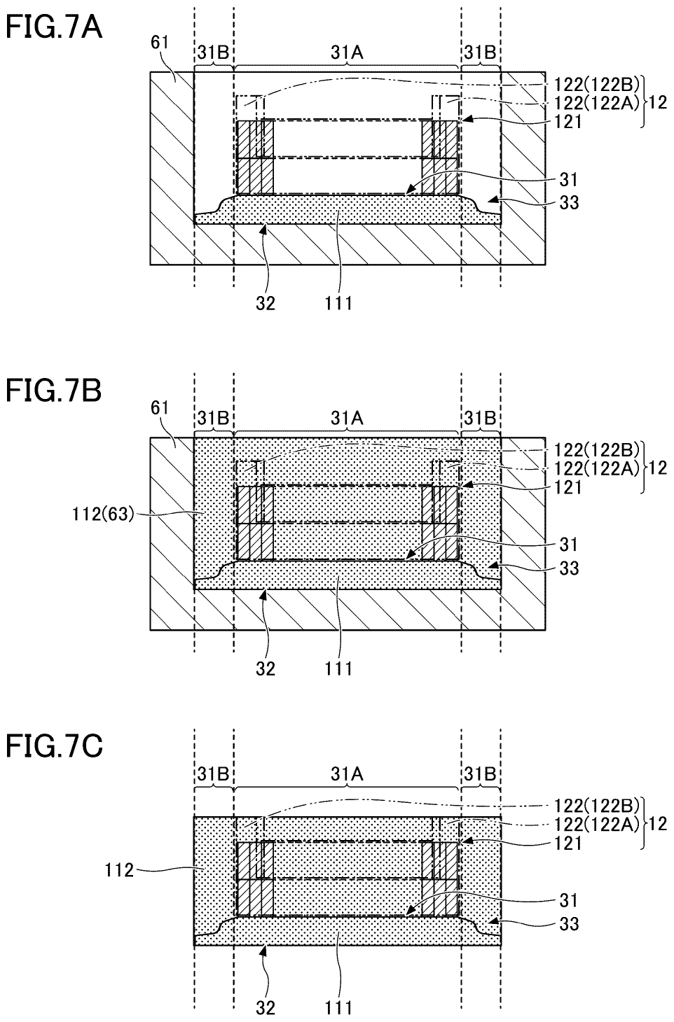

Each process will be described in the following by using drawings as necessary. FIGS. 6A to 6C and FIGS. 7A to 7C are cross-sectional views of the coil conductor 12 included in the coil component 10 to be manufactured, at a position passing through the central axis CA. Although the lead-out portions 122 are not included in the cross-sectional views of the coil conductor 12 included in the coil component 10 to be manufactured, at a position passing through the central axis CA, the lead-out portions 122 are illustrated in FIGS. 7A to 7C by a two-dot dash line such that an operation in each manufacturing process can be clearly understood.

### (1) First-Base Formation (S51)

In the first-base formation, the first base including the first surface provided with the first area that is a continuous flat surface and the second area other than the first area can be formed.

In the first-base formation, the first base can be formed by compression molding, warm molding, or sheet molding.

In the first-base formation, for example, as illustrated in FIG. 6A, a molding die 61 can be filled with a first magnetic composite material obtained by kneading a plurality of first metal magnetic particles and a binder. The binder can contain a first resin which is a resin. As for the first metal magnetic particles and the first resin contained in the first magnetic composite material, the description will be omitted in the following because the metal magnetic particles and the resins contained in the base 11 described above can be suitably used. If necessary, the first magnetic composite material may contain inorganic particles or the like described as contained in the base 11.

Then, the first base 111 can be formed by applying a molding pressure to the first magnetic composite material, which increases a filling rate of the first magnetic composite material, at a temperature lower than a thermosetting temperature of the resin contained in the first magnetic composite material. It should be noted that the first magnetic composite material is not completely cured in the first-base formation, but may be completely cured at the time of forming the second base in the second-base formation. Therefore, the first-base formation may be referred to as a first-base precursor formation, and the first-base formation may be referred to as forming a first-base precursor.

When the molding pressure is applied to the first magnetic composite material in the molding die 61, in the case of manufacturing the base 11 of the first configuration example, the first base 111 can be molded to include the first area 31A, which is a continuous flat surface, and the second area 31B other than the first area 31A, with respect to the first surface 31, which is one of the surfaces of the first base 111. In this case, the first base 111 can be formed to include the recess 33 in the second area 31B of the first surface 31. Since the preferred size of the recess 33 has already been described, the description will be omitted here.

Note that even in the case of manufacturing the base 11 of the second configuration example, the first base 111 may be formed to include a recess in the second area 31B, or may be formed to have a shape other than a recess. In the case of manufacturing the base 11 of the second configuration example, the shape of the second area 31B can be selected to form the transition area 40. In the case of manufacturing the base 11 of the second configuration example, as illustrated in FIG. 6B, for example, the first base 111 may include projections 62 on its side surfaces. The size and number of the projections 62 can be selected such that the transition area 40 is formed by collapsing the projections 62 when a second magnetic composite material is supplied or when the molding pressure is applied in the second-base formation and mixed with the first magnetic composite material. Therefore, the configuration of the projections 62 of the first base 111 is not limited to the example as illustrated in FIG. 6B. For example, as illustrated in FIG. 6C, the first base 111 may have a configuration having a plurality of small projections 62 on its side surfaces.

When the base of the second configuration example is manufactured, granules or the like of the first magnetic composite material may be arranged in the vicinity of the area for forming the transition area 40 such as on the side surfaces of the first base 111.

### (2) Coil Conductor Installation (S52)

In the coil conductor installation (S52), as illustrated in FIG. 7A, the coil conductor 12 can be installed in the first area 31A, which is a continuous flat surface of the first surface 31 of the first base 111 formed in the first-base formation.

The coil conductor 12 can be prepared in advance by winding a metal band around a core metal by using a known wire-winding machine such as a spindle-type wire-winding machine.

### (3) Second-Base Formation (S53)

In the second-base formation (S53), as illustrated in FIG. 7B, the second base 112 can be formed to cover the first surface 31 of the first base 111 and the coil conductor 12.

In the second-base formation, the second base can be formed by compression molding, warm molding, or sheet molding.

In the second-base formation, for example, as illustrated in FIG. 7B, the molding die 61 can be filled with the second magnetic composite material obtained by kneading a plurality of second metal magnetic particles and a binder. The binder can contain a second resin, which is a resin. The description of the second metal magnetic particles and the second resin is omitted here because the metal magnetic particles and the resins that can be contained in the base 11 described above can be suitably used. The second magnetic composite material may contain inorganic particles or the like that can be contained in the base 11, if necessary. It should be noted that the first magnetic composite material and the second magnetic composite material may contain materials such as the metal magnetic particles of the same type or composition, or of different types or compositions.

The second base 112 can be formed by applying a molding pressure to the second magnetic composite material to increase the filling rate of the second magnetic composite material at a temperature equal to or higher than the thermosetting temperature of the resin contained in the second magnetic composite material. When forming the second base 112 in the second-base formation, it is preferable to select the temperature used for heating such that the temperature is equal to or higher than the thermosetting temperature of the resin contained in the first magnetic composite material. By selecting the temperature at which the second base 112 is formed in the second-base formation such that the temperature is equal to or higher than the thermosetting temperature of the resin contained in the first magnetic composite material, the resin contained in the first base 111 can also be cured when forming the second base 112.

The molding die 61 may be different between the first-base formation (S51) and the second-base formation (S53). In this case, for example, the molding die can be changed after the first-base formation (S51) and before the coil conductor installation (S52).

Since an excess portion can be removed in the polishing (S54) described in the following, a molded member 63 greater in size than a target second base 112 can be formed in the second-base formation.

When the base 11 of the first configuration example is to be manufactured, the second base 112 can be formed in the second-base formation such that the second base 112 is also filled into the recess 33. Specifically, the molding die 61 is filled with the second magnetic composite material such that the recess 33 is filled with the second base 112, and the molding pressure is applied to the second magnetic composite material.

When the base 11 of the second configuration example is to be manufactured, in the second-base formation, the second base 112 can be formed such that the transition area 40 is formed between the second area 31B of the first base 111 and the second base 112. Specifically, the composition of the second magnetic composite material and the pressure applied to the second magnetic composite material can be selected such that the transition area 40 is formed.

The first base 111 obtained in the first-base formation and the second base 112 obtained in the second-base formation can contain metal magnetic particles and a binder.

### (4) Polishing (S54)

In the polishing (S54), as illustrated in FIG. 7C, an upper surface of the molded member 63, which is the surface opposite to the surface on which the first base 111 is arranged as illustrated in FIG. 7B, can be polished to expose the first lead-out portion 122A and the second lead-out portion 122B of the coil conductor 12. By polishing the molded member 63, the size of the second base 112 can be set to a desired size.

### (5) External Electrode Formation (S55)

In the external electrode formation (S55), the external electrodes 13 can be formed by applying a conductive paste to the surface of the base 11. The external electrodes 13 can be provided on the surface of the base 11 to be electrically connected to the first lead-out portion 122A and the second lead-out portion 122B of the coil conductor 12. The external electrodes 13 may include a Ni plating layer, a Sn plating layer, a conductive resin layer, or the like.

According to the present disclosure, a coil component capable of preventing the base from being damaged even when the base is repeatedly subjected to thermal-processing cycles, is provided.

The coil component 10 can be manufactured as described above. However, the method for manufacturing the coil component 10 is not limited to the above-described manufacturing method. At least either of the first base 111 or the second base 112 may be manufactured by transfer molding or by using a sheet lamination method instead of the compression molding.

An embodiment of the present disclosure is, for example, as follows.

<1> A coil component, comprising:
a base including a metal magnetic particle and a binder; and
a coil conductor arranged in the base, wherein
the base includes a first base and a second base,
the first base includes a first surface facing the coil conductor,
the first surface includes a first area that is a continuous flat surface and a second area other than the first area,
the second base is connected to the first base at least in the second area of the first base, and
the first base includes a recess in the second area.

<2> The coil component according to <1>, wherein
a depth of the recess based on a position of the first area is longer than a major-axis diameter of one or more kinds of particles selected from a first metal magnetic particle that is the metal magnetic particle included in the first base, and a second metal magnetic particle that is the metal magnetic particle included in the second base.

<3> A coil component, comprising:
a base including a metal magnetic particle and a binder; and
a coil conductor arranged in the base, wherein
the base includes a first base and a second base,
the first base includes a first surface facing the coil conductor,
the first surface includes a first area that is a continuous flat surface and a second area other than the first area,
the second base is connected to the first base at least in the second area of the first base, and
a transition area is provided between the second area of the first base and the second base.

<4> The coil component according to any one of <1> to <3>, wherein
in a cross section passing through a central axis of the coil conductor, a length of the first area is 80% or less of a length of the base along the first surface in the cross section.

<5> A method for manufacturing a coil component, the method comprising:
first-base formation for forming a first base including a first surface provided with a first area that is a continuous flat surface, and a second area other than the first area;
coil conductor installation for installing a coil conductor in the first area of the first surface of the first base; and
second-base formation for forming a second base to cover the first surface of the first base and the coil conductor, wherein
each of the first base and the second base includes a metal magnetic particle and a binder,
the first base includes a recess in the second area, and
the second base is formed such that the second base is also filled into the recess in the second-base formation.

<6> A method for manufacturing a coil component, the method comprising:
first-base formation for forming a first base including a first surface provided with a first area that is a continuous flat surface, and a second area other than the first area;
coil conductor installation for installing a coil conductor in the first area of the first surface of the first base; and
second-base formation for forming a second base to cover the first surface of the first base and the coil conductor, wherein
each of the first base and the second base includes a metal magnetic particle and a binder, and
in the second-base formation, the second base is formed to form a transition area between the second area of the first base and the second base.

What is claimed is:

1. A coil component, comprising:
a base including a metal magnetic particle and a binder; and
a coil conductor arranged in the base, wherein
the base includes a first base and a second base,
the first base includes a first surface facing the coil conductor,
the first surface includes a first area that is a continuous flat surface and a second area other than the first area,
the second base is connected to the first base at least in the second area of the first base, and
the first base includes a recess in the second area.

2. The coil component according to claim 1, wherein
a depth of the recess based on a position of the first area is longer than a major-axis diameter of one or more kinds of particles selected from a first metal magnetic particle that is the metal magnetic particle included in the first base, and a second metal magnetic particle that is the metal magnetic particle included in the second base.

3. A coil component, comprising:
a base including a metal magnetic particle and a binder; and
a coil conductor arranged in the base, wherein
the base includes a first base and a second base,
the first base includes a first surface facing the coil conductor,
the first surface includes a first area that is a continuous flat surface and a second area other than the first area,
the second base is connected to the first base at least in the second area of the first base, and
a transition area is provided between the second area of the first base and the second base.

4. The coil component according to claim 1, wherein
in a cross section passing through a central axis of the coil conductor, a length of the first area is 80% or less of a length of the base along the first surface in the cross section.

5. The coil component according to claim 3, wherein
in a cross section passing through a central axis of the coil conductor, a length of the first area is 80% or less of a length of the base along the first surface in the cross section.

6. The coil component according to claim 1, wherein
in a cross section along a height direction of the base, the recess has a wavy shape.
